(19) United States
(12) Patent Application Publication
(10) Pub. No.: US 2007/0000938 A1
(43) Pub. Date: Jan. 4, 2007

(54) Tablet dispenser

(76) Inventor: Michel C. Renaud, Prangins (CH)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/410,824

(22) Filed: Apr. 25, 2006

Related U.S. Application Data
(60) Provisional application No. 60/674,846, filed on Apr. 26, 2005.

(51) Int. Cl. B65G 59/00

(52) U.S. Cl. 221/263

(57) ABSTRACT

A tablet dispenser has a tablet container within a housing. The container is slidably mounted to-and-fro, a part of the container being accessible so it can be moved from a rest position to a tablet-distribution position against the action of a spring. The container has a tablet-distribution channel that in the tablet-distributing position protrudes from one side of the housing. A bottom of the tablet container is delimited by a spring-forming inclinable transverse member movably or resiliently connected at one end with the container and at the other end to the housing. When the container is moved to the tablet-distributing position, the member is displaced inside the container to shake the tablets and form an inclined bottom leading to the tablet-distribution channel, thereby improving tablet dispensing reliability.

This application claims the benefit of U.S. Provisional Application No. 60/674,846, filed Apr. 26, 2005.

### FIELD OF THE INVENTION

The present invention relates to a tablet dispenser. More particularly, the present invention relates to a tablet dispenser for individually dispensing tablets, including a hollow housing that has an open first end and a closed second end, with a laterally-offset tablet distribution orifice at one side of the closed second end, a tablet container slidably mounted in the housing to-and-fro, between a rest position in which the container is located towards the open first end and a tablet-distribution position in which the container is located towards the closed second end, and a spring that acts between the housing and the container to bias the container from the tablet-distribution position to the rest position.

### BACKGROUND OF THE INVENTION

The following disclosures may be relevant to various aspects of the present invention and may be briefly summarized as follows.

Dispensers for individually dispensing tablets by means of a limited to-and-fro displacement of an inner part into a housing, wherein a tablet is discharged through a tablet discharge shaft at an opening on the base side are known. For example, EP 0 345 413-B1 discloses a tablet dispenser that dispenses an individual tablet through an opening on the base side in a housing by pressing in an actuating key that is connected with a slide via a central actuating shaft. A disadvantage of this known dispenser is that tablet fragments and rubbed off portions exit easily when the dispenser is used and carried in pockets of clothing, handbags or the like.

DE-U-2 96 01 693.4 suggests disclosing gap-closing elements at the housing and at the inner part of a tablet dispenser that has a prismatic housing with an open top end and a laterally-offset opening in the base surface. An inner part is inserted into the housing, this inner part comprising a slide and an actuating key connected by a connection element which, together, form a structural unit having an inner housing forming a tablet reservoir space in its upper part. By pressing with a finger on the upper part of the actuating key, the inner part is displaced and its slide passes through the base opening of the housing to release a tablet. The displacement of the inner part is limited with respect to lift by a crosspiece or web that strikes the housing base during the downward movement of the inner part, blocking further downward movement.

EP 0 345 413-B1 discloses a tablet dispenser constructed with inclined surfaces in the region of the discharge shaft to prevent bridging within the bulk of tablets that would impede discharge of the tablets. These inclined surfaces, in combination with the actuation of the slide, provide for an individual discharge of the tablets, and reduce the risk of breakage of the tablets by shaking.

DE-U-2 96 01 693.4 discloses a tablet dispenser housing formed at its inside with parallel, vertically oriented ribs projecting inward, these ribs engage in longitudinal slits of the connection element to loosen the tablets when the slide moves out of its rest position into its discharging position to loosen or free tablet in the upper region of the tablet dispenser.

U.S. Pat. No. 6,273,294 discloses a tablet dispenser with a prismatic housing whose base surface has a base opening that is offset toward an end face and whose top surfaces open over its entire cross section and whose side surfaces each have a cutout at the top, with an inner part being inserted into the housing through the open top surface and being displaceable so as to be limited with respect to upward movement and comprising a preferably prismatic tablet reservoir space, an essentially vertically oriented tablet discharge shaft being provided at the base of the tablet reservoir space and extended through the base opening of the housing, and including a spring which is supported against the base surface of the housing and a web for limiting upward movement, and a web or rib arranged at the inner side wall of the housing in a working connection with the outer side wall of the inner part during the displacement of the inner part. The provision of a web or rib in the inner side-wall of the housing is intended for loosening the tablet bulk during the displacement of the inner part into the housing. When the tablet dispenser is used, the inner part is pushed into the housing up to a stop by finger pressure so that an individual tablet is released from the tablet discharge shaft, and the web or rib is pressed laterally against a flexible side wall of the inner part, intended to induce a shaking movement Within the tablet bulk in the inner part, as a result of which tablets should fall into the discharge shaft for individual discharge. However, the tablet-shaking effect of these integral ribs has not proven to be reliable: the dispensing mechanism is liable to get blocked or bottleneck effects may occur, and the tablets are not reliably dispensed.

Thus, it is desirable to provide an individually dispensing tablet dispenser without the limitations of the prior art as described above for enhanced reliable tablet dispensing.

### SUMMARY OF THE INVENTION

Briefly stated, and in accordance with one aspect of the present invention, there is provided a tablet dispenser for individually dispensing tablets comprising: a hollow housing that has an open first end and a closed second end, with a laterally-offset tablet distribution orifice at one side of the closed second end, a tablet container slidably mounted in the housing to-and-fro, between a rest position in which the container is located towards the open first end, and a tablet-distribution position in which the container is located towards the closed second end, and a spring that acts between the housing and the container to bias the container from the tablet-distribution position to the rest position, wherein: a part of the tablet container is accessible through the open first end of the housing to allow the container to be moved by hand from the rest position to the tablet-distribution position against the action of the spring; the tablet container has a tablet-distribution channel located on one side so that when the container is moved to the tablet-distributing position the channel comes to protrude from said orifice of the housing, for distributing a tablet; a bottom of a tablet-containing volume of the tablet container is delimited by an inclinable transverse member; a first end of the transverse member is movably connected with the tablet container adjacent to the tablet-distribution channel; and a second end of the transverse member is movably connected with the housing, such that when the tablet container is moved to the tablet-distributing position the second end of the transverse member is displaced inwardly inside the tablet container so the transverse member forms an inclined bottom of the tablet containing volume leading to the tablet-distribution channel.

Pursuant to another aspect of the present invention, there is provided a part of the tablet container is accessible through the open first end of the housing to allow the container to be moved by hand from the rest position to the tablet-distribution position against the action of the spring; and the tablet container has a tablet-distribution channel located on one side so that when the container is moved to the tablet-distributing position the channel comes to protrude from the laterally-offset tablet-distribution orifice of the housing, for distributing a tablet.

According to the invention, a bottom of a tablet-containing volume of the tablet container is delimited by an inclinable transverse member. A first end of this transverse member is movably or resiliently connected with the tablet container adjacent to the tablet-distribution channel; and a second end of the transverse member is movably or resiliently or flexibly connected with the housing, such that when the tablet container is moved to the tablet-distributing position the second end of the transverse member is displaced inwardly inside the tablet container so the transverse member forms an inclined bottom of the tablet containing volume leading to the tablet-distribution channel.

Thus, during tablet dispensing, the mechanism does not rely solely on gravity feed of the tablets, but gravity feed of the tablets is complemented by an additional dynamic movement or shaking effect by the displacement and the inclination of the transverse member which forms a tablet-shaking action arm actuated by the user pushing the container inside the housing, so the shaken tablets are guided down the dynamically inclined transverse member towards the tablet-dispensing channel. As a result, the device of the present invention provides enhanced tablet distribution reliability.

### BRIEF DESCRIPTION OF THE DRAWINGS

The invention will be more fully understood from the following detailed description, taken in connection with the accompanying drawings, in which:

FIG. 1 is a perspective view of a tablet dispenser according to the invention;

FIG. 2 is a cross-sectional view showing the inner tablet container of this tablet dispenser in the rest position;

FIG. 3 is a cross-sectional view showing the inner tablet container in the tablet-dispensing position.

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

### DETAILED DESCRIPTION OF THE INVENTION

The present invention concerns a tablet dispenser for individually dispensing tablets, comprising: a hollow housing that has an open first end and a closed second end, with a laterally-offset tablet distribution orifice at one side of the closed second end; a tablet container slidably mounted in the housing to-and-fro, between a rest position in which the container is located towards the open first end, and a tablet-distribution position in which the container is located towards the closed second end; and a spring that acts between the housing and the container to bias the container from the tablet-distribution position to the rest position. The housing may be generally prismatic.

Reference is now made to the drawings for a detailed description of the present invention.

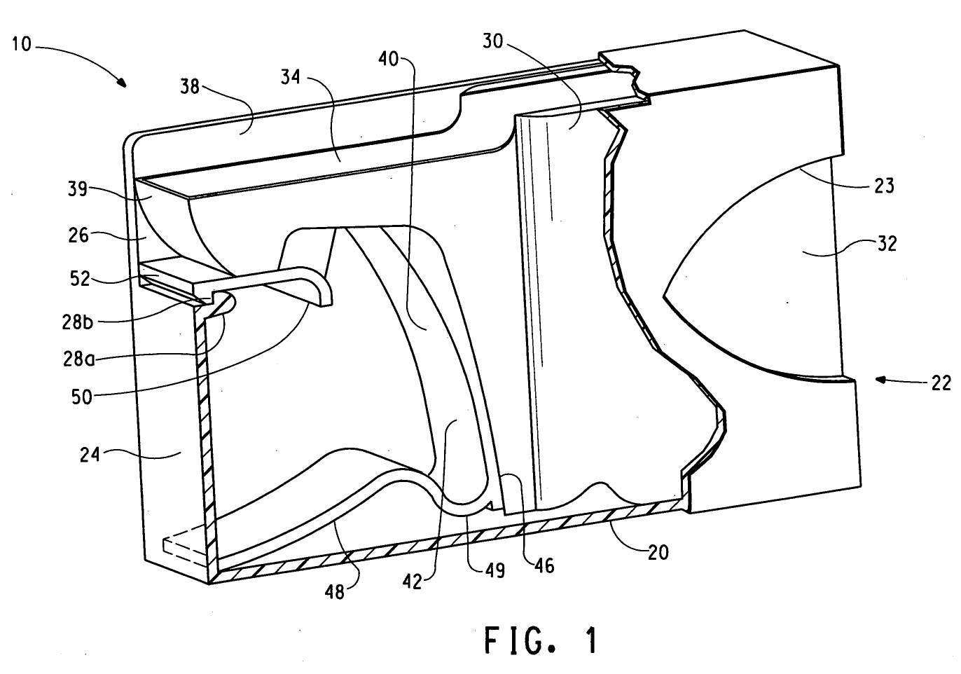

FIGS. 1 to 3 show a preferred embodiment of the tablet dispenser 10 according to the invention, for individually dispensing tablets 12 contained in an inner tablet container 30 within a generally rectangular prismatic hollow outer housing 20. This housing 20 has an open first or top end 22 and a closed second or bottom end 24, with a laterally-offset tablet distribution orifice 26 at one side of the closed bottom end 24.

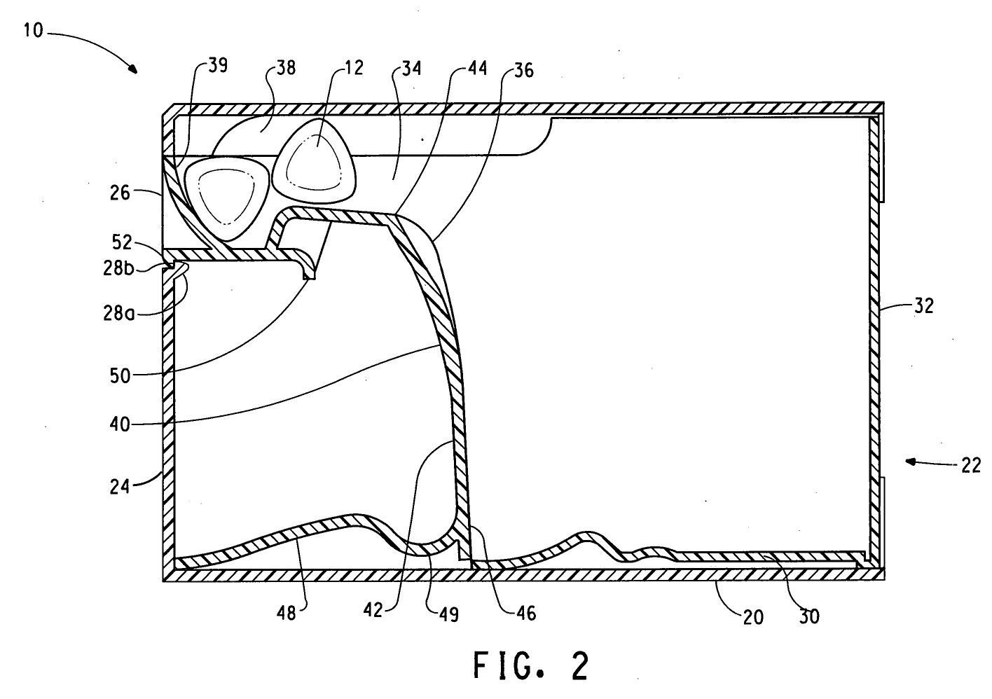

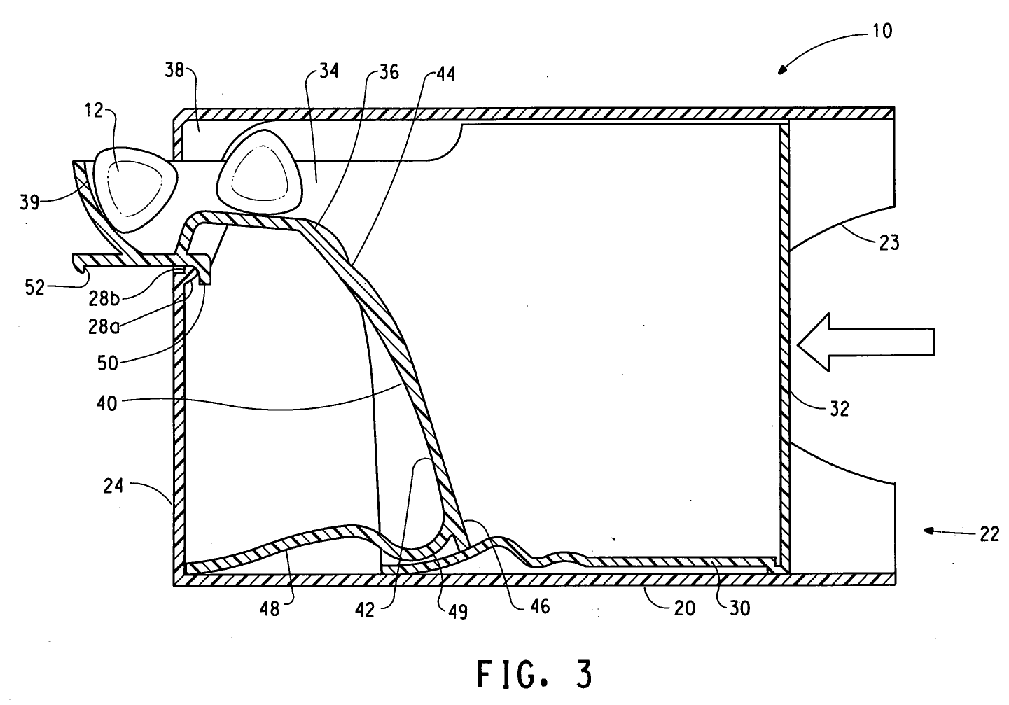

The tablet container 30 is slidably mounted in the housing 20 to-and-fro, between a rest position (FIG. 2) in which the container 30 is located towards the open first end 22, and a tablet-distribution position (FIG. 3) in which the container 30 is located towards the closed second end 24.

A spring 40 acts between the housing 20 and the container 30 to bias the container from the tablet-distribution position to the rest position. As discussed below, this spring 40 is integral with an inclinable transverse member 42 that closes an open bottom of the housing 20. A part 32 of the tablet container 30 is accessible through the open first end 22 of the housing 20 to allow the container to be moved by hand from the rest position to the tablet-distribution position against the action of the spring 40. For this purpose, the first open end 22 of the housing 20 has opposite apertures 23 allowing access to the opposite sides of the top part 32 of the tablet container 30.

The tablet container 30 has a tablet-distribution channel 34 located on one side so that when the container 30 is moved to the tablet-distributing position the channel 34 comes to protrude from the tablet-distribution orifice 26, as shown in FIG. 3, for distributing a tablet 12 sideways.

Conveniently, the upper part of the tablet container 30 is broader in width than its lower part adjacent to its lower bottom opening 36 and the transverse member 42, so the upper part forms a tablet reservoir where tablets 12 are stacked to fill the container's width, and the lower part contains a single row of tablets for distribution via the channel 34.

The aforementioned inclinable transverse member 42 forms a bottom of the tablet container 30, delimiting an internal tablet-containing volume thereof. A first end 44 of the transverse member 42 is movably or resiliently or flexibly connected with the tablet container 30 adjacent to the top of the tablet-distribution channel 34. A second end 46 of the transverse member 42 is movably or resiliently or flexibly connected with the housing 20, such that when the tablet container 30 is moved to the tablet-distributing position of FIG. 3 the second end 46 of the transverse member 42 is displaced inwardly inside the tablet container 30 so the transverse member 42 forms an inclined bottom of the tablet containing volume leading to the tablet-distribution channel 34.

In the illustrated preferred embodiment, the transverse member 42 constitutes the spring 40. Also, the second end 46 of the transverse member 42 is integral with an arm 48 connected to the closed second end 24 of the housing 20. This second end 46 of the transverse member 42 is connected to arm 48 by a hinge section 49. The tablet container 30, the tablet-distribution channel 34 and the transverse member 42, together with its arm 48 and hinge section 49, are advantageously all molded in a single part of plastics material such as POM (Polyoxymethylene) which has good mechanical properties and provides adequate resilience.

The illustrated tablet dispenser also has an abutment 50 on the outside of the tablet-distribution channel 34 for stopping the tablet container 30 in the tablet-distribution position, by abutment against an inwardly-facing abutment surface 28a of the closed second end 24 of the housing. A locking element 52 is provided on the tablet distribution channel 34 for cooperating with an outwardly-facing abutment surface 28b of the closed second end 24 of the housing to releasably retain the tablet container 30 in the rest position. The distance between the abutment 50 and the abutment surface 28a determines the stroke of the to-and-fro movement of the container 30.

As shown, in the rest position of FIG. 2 the transverse member 42 is inclined slightly towards the tablet-distribution channel 34, whereas in the tablet-distribution position of FIG. 3 the transverse member 42 is inclined much more steeply towards the tablet-distribution channel 34. During its displacement, the transverse member 42 may maintain its crosswise shape, which can be straight or curved, or it may bow. The crosswise shape of transverse member 42 can be constant all along the member profile, from its first end 44 until its second end 46. It can also be tapered by either local wall thickness variations or by stiffening ribs, or by the combination of both, between its first end 44 until its second end 46, preferably being thinner at its second end 46. The rotation angle can vary locally from 5° up to 75°.

The illustrated tablet container 30 has a bottom opening 36 that extends transversally across the tablet container, from a location adjacent to the tablet distribution channel 34 to a location towards the container's opposite side, and the tablet container's bottom opening 36 is obturated by the transverse member 42. Thus, the transverse member 42 provides the combined functions of forming the bottom of the container 30, acting as a tablet shaker, and as a spring. of container 30, to prevent the egress of any dust or fragments of the tablets 12. Also as illustrated by way of example, the tablet-distribution orifice 26 is located in the lower closed end 24 of the housing 20, and the tablet-distribution channel 34 includes a neck part 38 leading to an outwardly-inclined terminal tablet delivery surface 39 that protrudes from orifice 26 to deliver a tablet 12 towards the outer side face of the housing 20 when the container 30 is moved to the tablet-distribution position. The neck part 38 is configured and dimensioned to provide smooth delivery of individual tablets 12.

For use, the inner container 30 is filled with identical tablets 12 which can have various shapes such as ovoid, spherical, disk-shaped or lozenge-shaped. The neck part 38 of the tablet distribution channel 34 is adapted to allow passage of the tablets 12 individually.

To dispense a tablet, the user holds the housing 20 in the usual way with the end 22 at the top, and moves the container 30 down to the tablet-distributing position by applying pressure on the accessible top part 32. As the channel 34 is pushed down to the tablet-distributing position, the member 42 is caused to incline by abutment of the arm 48 against the closed bottom end 24 with the resilient spring part 40 and the hinge section 49 bowing. As a result, the transverse member's 42 second end 46 moves abruptly against the tablets 12 in the bottom of the container 30, providing a tablet shaking effect. This shaking effect is coupled with the inclination of the transverse member 42 towards the tablet-distribution channel 34, so the shaken tablets 12 are guided down into the distribution channel 34. Tests have demonstrated that the just-described shaking effect provides a more reliable tablet distribution than any of the prior devices. The stroke of the to-and-fro movement is positively set at a desired value by the spacing of the abutment 50 on the tablet distribution channel and the abutment surface 28a.

Advantageously, the tablet container 30, the tablet-distribution channel 34 and the transverse member 42 are all molded in a single part, or alternatively, the tablet container 30, the tablet-distribution channel 34 and the transverse member 42, together with said arm 48 and said hinge section 49 where provided, are all

The tablet dispenser of the invention is advantageously made from a thermoplastic material. Preferred materials for any of the tablet dispenser parts are selected from polyacetal, poly olefins (such as polypropylene and polyethylene), polyesters (such as polybutylene terephthalate and polyethylene terephthalate), polycarbonate, polystyrene, acrylonitrile-butadiene-styrene (ABS), and mixtures of these. The housing 20 may be made of one material, and the tablet container 30 of another material. (Other parts in the present invention may be made of different material. For example, the arm 48 and the spring may be made from different materials with differing flexibility.) Most preferably the spring 40 is made of polyacetal. Particularly preferably the container 30, the transverse member 42, the channel 34, the arm 48 and the hinge 49 are made of polyacetal (POM).

It is therefore, apparent that there has been provided in accordance with the present invention, a tablet dispenser that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A tablet dispenser for individually dispensing tablets comprising:
hollow housing that has an open first end and a closed second end, with a laterally-offset tablet distribution orifice at one side of the closed second end,
a tablet container slidably mounted in the housing to-and-fro, between a rest position in which the container is located towards the open first end, and a tablet-distribution position in which the container is located towards the closed second end, and
a spring that acts between the housing and the container to bias the container from the tablet-distribution position to the rest position, wherein:
a part of the tablet container is accessible through the open first end of the housing to allow the container to be moved by hand from the rest position to the tablet-distribution position against the action of the spring; the tablet container has a tablet-distribution channel located on one side so that when the container is moved to the tablet-distributing position the channel comes to protrude from said orifice of the housing, for distributing a tablet;
a bottom of a tablet-containing volume of the tablet container is delimited by an inclinable transverse member;
a first end of the transverse member is movably connected with the tablet container adjacent to the tablet-distribution channel; and
a second end of the transverse member is movably connected with the housing, such that when the tablet container is moved to the tablet-distributing position the second end of the transverse member is displaced inwardly inside the tablet container so the transverse member forms an inclined bottom of the tablet containing volume leading to the tablet-distribution channel.

2. The tablet dispenser of claim 1 wherein the transverse member constitutes the spring.

3. The tablet dispenser of claim 1 wherein the second end of the transverse member is integral with an arm abutted to the closed second end of the housing.

4. The tablet dispenser of claim 3 wherein the second end of the transverse member is connected to said arm by a hinge section.

5. The tablet dispenser of claim 4 wherein the tablet container, the tablet-distribution channel and the transverse member, together with said arm and said hinge section where provided, are all molded in a single part.

6. The tablet dispenser of claim 1 wherein the tablet container, the tablet-distribution channel and the transverse member are all molded in a single part.

7. The tablet dispenser of claim 1 comprising an abutment on the tablet-distribution channel for stopping the tablet container in the tablet-distribution position, by abutment against an inwardly-facing abutment surface of the closed second end of the housing.

8. The tablet dispenser of claim 1 comprising a locking element on the tablet distribution channel for cooperating with an outwardly-facing abutment surface of the closed second end of the housing to releasably retain the tablet container in the rest position.

9. The tablet dispenser of claim 1 wherein in the rest position the transverse member is inclined slightly towards the tablet-distribution channel, and in the tablet-distribution position the transverse member is inclined more steeply towards the tablet-distribution channel.

10. The tablet dispenser of claim 1 wherein the tablet container has a bottom opening that extends transversally across the tablet container, from a location adjacent to the tablet distribution channel to a location towards the container's opposite side, and the tablet container's bottom opening is obturated by said transverse member.

11. The tablet dispenser of claim 1 wherein the tablet-distribution orifice is located in the second closed end of the housing, and wherein the tablet-distribution channel includes a neck part leading to an outwardly-inclined terminal tablet delivery surface that protrudes from said orifice to deliver a tablet towards the outer side face of the housing when the container is moved to the tablet-distribution position.

12. The tablet dispenser of claim 1 wherein the first open end of the housing has opposite apertures allowing access to a top part of the tablet container.
